(19) United States
(12) Patent Application Publication
(10) Pub. No.: US 2007/0253352 A1
(43) Pub. Date: Nov. 1, 2007

(54) DETERMINISTIC POWER-AWARE WIRELESS NETWORK

(75) Inventors: Khaled A. Arisha, Bellevue, WA (US); Aloke Roy, Gaithersburg, MD (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/381,021

(22) Filed: May 1, 2006

(51) Int. Cl. H04Q 7/00

(52) U.S. Cl. 370/328

(57) ABSTRACT

A method to manage an application-layer-managed network. The method includes receiving a received signal strength indication at an application layer of an access node from a media access control layer of the access node, determining if the received signal strength indication or an averaged received signal strength indication are within a selected range of received signal strength indication. The method also includes transmitting a power-level-adjustment signal to the media access control layer based on the determination. The power-level-adjustment signal adjusts a transmission power level of at least one of a plurality of network nodes.

### BACKGROUND

A wireless network implementing the Institute of Electrical and Electronics Engineers (IEEE) 802 standards cannot be used in applications that require time-critical reliable deterministic performance. This limitation is due to the collision-based carrier-sense-multiple-access media access control (CSMA-MAC) protocol specified in the IEEE 802 standards. Wireless devices implemented according to the IEEE 802.11 standard, use the contention-based carrier-sense-multiple access/collision avoidance (CSMA/CA) protocol for the media access control layer. CSMA systems are inefficient and become unstable as the load increases due to terminal collisions.

Most of wireless devices implemented according to the IEEE 802.11 standard are in contention mode, except for an inflexible contention-free point-coordinated function (PCF). In this case, the access points in the network use the PCF to poll each node in the network for data to send. The polling is done in a preset order. However, the PCF network periodically enters a contention period where each node competes for the channel using random back-offs. Since the access point can not poll a sleeping node, the nodes with data to send have to keep their radios on all the time or wait for the PCF to enter its contention period. For high-volume real-time data delivery, most of the data streams will be transmitted during the contention period, leaving the contention free period underutilized.

Wireless network flexibility is limited by its physical layer and media access control layer capabilities. The access node in an unattended sensor network utilizes the time division multiple access- media access control (TDMA-MAC) protocol. In such systems, only the media access control layer is modified, with no upper layer alternative support. The standard active/sleep modes of commercial off the shelf (COTS) products do not permit extended periods of unattended operation for nodes in a wireless LAN that require reliable bi-directional communication.

In many military and civil applications, wireless networks of unattended sensors are used for security and disaster management. Such wireless networks process data gathered from multiple sensors to monitor events in an area of interest. Sensors in such systems are typically disposable and expected to last until their power source is depleted. In some cases, the sensors are battery-operated. If the sensor is active and transmitting at a high power level at all times, the lifetime of the battery is reduced. Therefore, energy has to be managed in order to extend the life of the sensors for the duration of a particular mission.

Sensors are generally equipped with data processing and communication capabilities. A sensing circuit measures parameters from the environment surrounding the sensor and transforms them into an electric signal. Processing such a signal reveals some properties about objects located and/or events happening in the vicinity of the sensor. The sensor communicates sensed data, to an access node. Signal processing and communication activities are the main consumers of sensor's energy.

There is a need to decrease energy consumption at nodes in a wireless network, especially when the wireless network consists of remotely deployed unattended sensors. Previous art has focused on improving hardware-related energy efficiency aspects of wireless communications. Low-power electronics, power-down modes, and energy efficient modulation are examples of work in this category.

Energy-aware routing has started to receive some attention in the recent few years, motivated by advances in wireless mobile devices. Since the overhead of maintaining the routing table for wireless mobile networks is very high, the stability of a route becomes a major concern. It is known that battery power capacity, transmission power, and stability of routes are among the issues to be considered in designing a power efficient routing protocol. Algorithms have been proposed to select the routes so the battery's drain-out time for the node is increased. The reported results have indicated that in order to increase battery lifetime, the traffic should be routed such that the energy consumption is balanced among the nodes in proportion to their energy reserves. The research on energy-aware wireless communication focuses on improving the physical layer (the radio). The research on transmit-power control uses complex models of communication environment in order to support mobile ad-hoc wireless networks.

In some applications, the nodes in a wireless LAN transmit information that, for security purposes, requires encryption. However, the security in wireless networks may not include the back-end server support.

There remains a long-felt need for methods of energy-aware network management that will ensure a desired level of quality-of-service (QoS), including encryption as needed, while maintaining the life of the network.

### SUMMARY

One aspect of the present invention provides a method to manage an application-layer-managed network. The method includes receiving a received signal strength indication at an application layer of an access node from a media access control layer of the access node, determining if the received signal strength indication or an averaged received signal strength indication are within a selected range of received signal strength indication. The method also includes transmitting a power-level-adjustment signal to the media access control layer based on the determination. The power-level-adjustment signal adjusts a transmission power level of at least one of a plurality of network nodes.

A second aspect of the present invention provides an application-layer-managed network that includes a plurality of network nodes, an access node having an application layer, the access node communicatively coupled to the plurality of network nodes, and a media access control layer. The application layer includes a transmit-power control protocol adapted to control transmission power levels of the plurality of network nodes and an encryption protocol adapted to provide secure, sylmmetric cryptography with dynamic key derivation. The media access control layer is in communication with the application layer of the access node. The media access control layer includes protocol for a time division multiple access scheme to prevent signal collisions among the linked network nodes. The application layer managed network provides energy aware priority and dynamic band width allocation for the linked network nodes communicating encrypted signals.

A third aspect of the present invention provides a program-product comprising program instructions embodied on a storage medium. The program instructions cause a programmable processor to receive a received signal strength indication at an application layer of an access node from a media access control layer of the access node, determine if the received signal strength indication or an averaged received signal strength indication are within a selected range of received signal strength indication, and transmit a power-level-adjustment signal to the media access control layer based on the determination. The power-level-adjustment signal adjusts a transmission power level of at least one of a plurality of network nodes.

### DRAWINGS

FIG. 1 is a block diagram of an embodiment of a wireless application-layer-managed network.

FIG. 2 is a block diagram of one embodiment of communication protocol stacks.

FIG. 3 is a block diagram of another embodiment of communication protocol stacks.

FIG. 4 is a block diagram of another embodiment of communication protocol stacks.

FIG. 5 is a block diagram of another embodiment of communication protocol stacks.

FIG. 6 is a flow diagram of one embodiment of a method to manage a wireless application-layer-managed network.

FIG. 7 is a flow diagram of one embodiment of a method to dynamically reconfigure slot assignments in a wireless application-layer-managed network.

FIG. 8 is a flow diagram of one embodiment of a method to encrypt data on signals received at a wireless application-layer-managed network.

In accordance with common practice, the various described features are not drawn to scale but are drawn to emphasize features relevant to the present invention. Reference characters denote like elements throughout figures and text.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

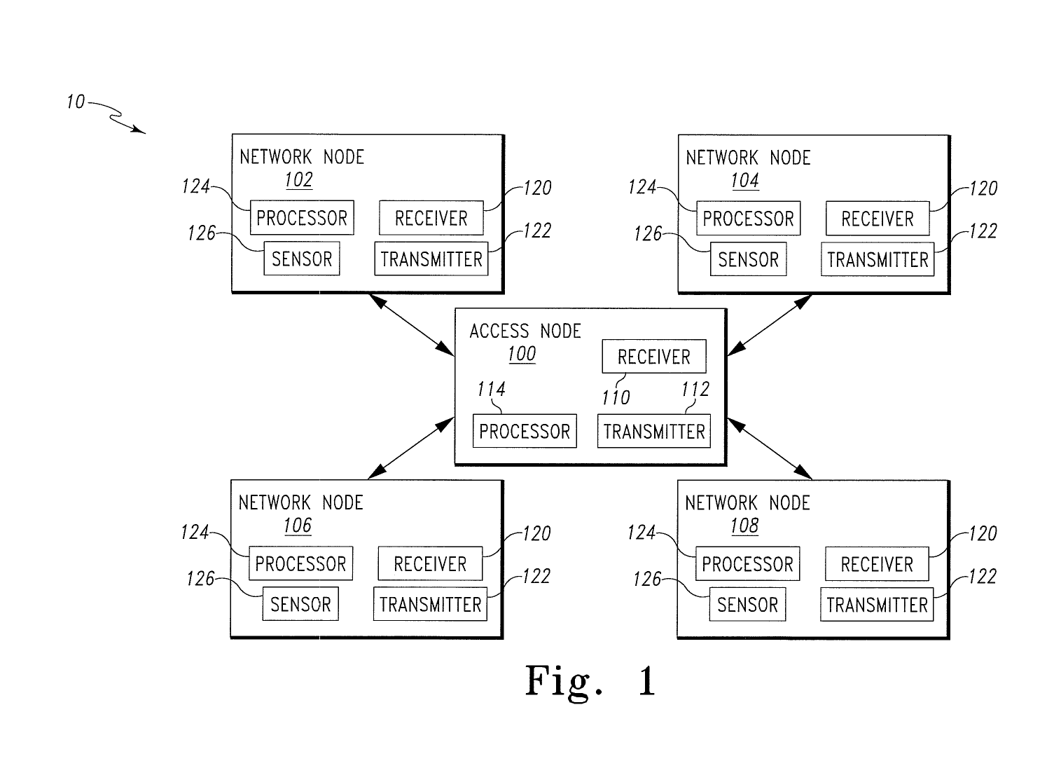

FIG. 1 is a block diagram of an embodiment of a wireless application-layer-managed network 10. The wireless application-layer-managed network 10 is also referred to here as a “power-aware network 10.” The wireless application-layer-managed network 10 includes an access node 100 in wireless communication with a plurality of network nodes 102-108 also referred to here as “network nodes 102-108.” The access node 100 includes one or more processors 114, a receiver 110 and a transmitter 112. In one implementation of this embodiment, the receiver 110 and transmitter 112 are one device such as a transceiver. At least one of the processors 114 is a power-aware processor 114.

The network nodes 102-108 each include a sensor 126, one or more processors 124, a receiver 120 and a transmitter 122. At least one of the processors 124 is a power-aware processor 124. In one implementation of this embodiment, the receiver 120 and transmitter 122 are one device referred to as a “transceiver.” In another implementation of this embodiment, the network nodes 102-108 do not include sensors 126.

By way of example and not by way of limitation, the term “wireless communication” includes a wireless connection via various devices and components implemented according wireless communication standards including IEEE 801.11, IEEE 801.15, IEEE 801.16, Bluetooth, ZigBee, and variations/extensions of these communication standards. The network nodes 100-108 transmit data in data packets. The linked nodes are also referred to here as “communicatively coupled nodes” in which the wireless connection is used in the exchange of information.

In one implementation of this embodiment, the network nodes 102-108 are wireless sensors that detect environmental parameters from the local environment of the network nodes 102-108. In another implementation of this embodiment, the wireless application-layer-managed network 10 is a wireless local area network (LAN) without sensor nodes.

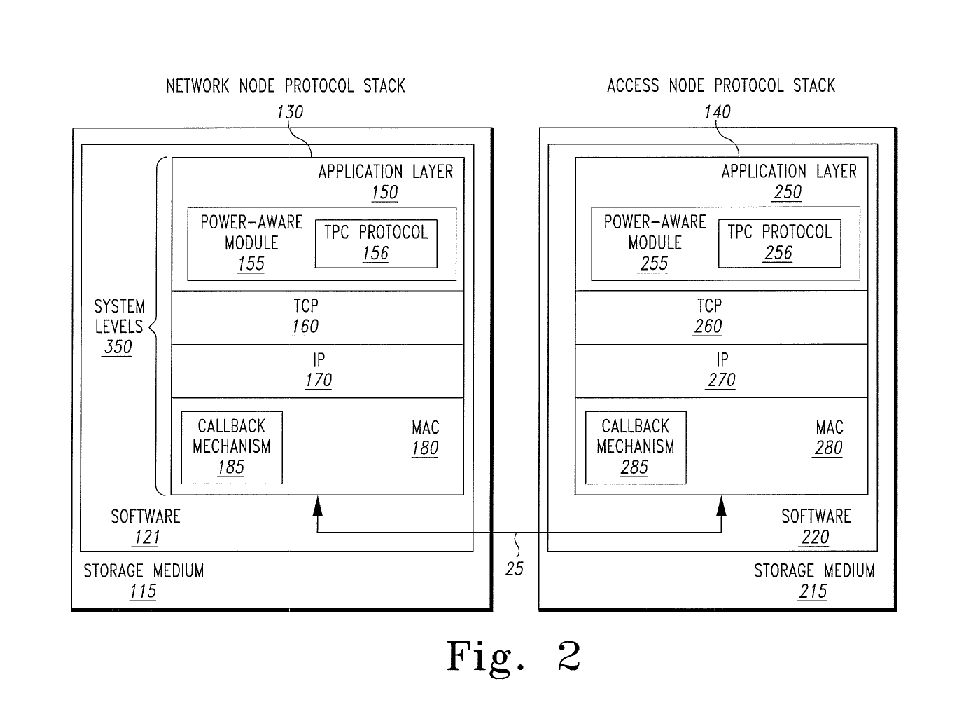

FIG. 2 is a block diagram of one embodiment of communication protocol stacks 130 and 140. The software 220 comprises appropriate program instructions that, when executed by processors 114 in the access node 100, cause the processor 114 to perform the processing described here as being carried out by the software 220. Such program instructions are stored on or otherwise embodied on one or more items of storage media 215 (only one of which is shown in FIG. 2). The software 121 comprises appropriate program instructions that, when executed by processors 124 in the network nodes 102-108, cause the processors 124 to perform the processing described here as being carried out by the software 121. Such program instructions are stored on or otherwise embodied on one or more items of storage media 115 (only one of which is shown in FIG. 2).

The communication protocol stack for the access node is generally indicated as 140. The communication protocol stack 140 is also referred to here as “access node protocol stack 140.” The communication protocol stack for the network nodes 102-108 is generally indicated as 130. The communication protocol stack 130 is also referred to here as “network node protocol stack 130.”The network node protocol stack 130 and the access node protocol stack 140 both include system levels 350. Some levels of the system level 350 are not illustrated here in order to emphasize the present invention. The wireless communication link between the network node and the access node is generally indicated by the double-ended arrow 25 connecting the network node protocol stack 130 and the access node protocol stack 140. The linked nodes are also referred to here as “communicatively coupled nodes” in which the wireless communication link 25 is used in the exchange of information.

The system levels 350 of the network node protocol stack 130 include an application layer 150, a transmission control protocol (TCP) layer 160, an internet protocol (IP) layer 170, and a media access control (MAC) layer 180. The transmission power control (TPC) protocol layer 156 controls transmission power levels of the network node 102-108 in which it is located. The application layer 150 is also referred to here as “user-level 150.” The application layer 150 includes a power-aware module 155 to process transmit-power-control packets received from the access node 100. The power-aware module 155 in the network node 102-108 includes transmit-power control (TPC) protocol 156.

The media access control layer 180 is in communication with the application layer 150 of the network node 102-108. The media access control layer 180 includes a callback mechanism 185, which provides a protocol-independent interface to various system levels 350 in each network node 102-208. The callback mechanism 185 includes hooks and filters that are implemented to link the required system levels 350 upon receipt of a filtered data packet at the network nodes 100, 102, 104, 106 or 108. In one implementation of this embodiment, the callback mechanism 185 is a Berkeley Packet Filter.

The system levels 350 of the access node protocol stack 140 include an application layer 250, a transmission control protocol (TCP) layer 260, an internet protocol (IP) layer 270, and a media access control (MAC) layer 280. The transmission power control (TPC) protocol layer 256 controls transmission power levels of the access node 100. The application layer 250 is also referred to here as “user-level 250.” The application layer 250 includes a power-aware module 255 also referred to here as “application-layer power-aware protocol 255.” The power-aware module 255 in the access node 100 includes transmit-power control (TPC) protocol 256 to determine when to send transmit-power-control packets to the network nodes 102-108. The media access control layer 280 is in communication with the application layer 250 of the access node 100. The media access control layer 280 includes a callback mechanism 285. In the same manner as described above with reference to the callback mechanism 185, the callback mechanism 285 provides a protocol-independent interface to various system levels 350 in the access node 100.

In one implementation of this embodiment, the access node protocol stack 140 is the same as the network node protocol stack 130. Similarly, in some implementations of this embodiment, one or more of the application layer 250, the transmission control protocol (TCP) layer 260, the internet protocol (IP) layer 270, the media access control (MAC) layer 280, the power-aware module 255 and the callback mechanism 285 are the same as one or more of the application layer 150, the transmission control protocol (TCP) layer 160, the internet protocol (IP) layer 170, the media access control (MAC) layer 180, the power-aware module 155 and the callback mechanism 185, respectively.

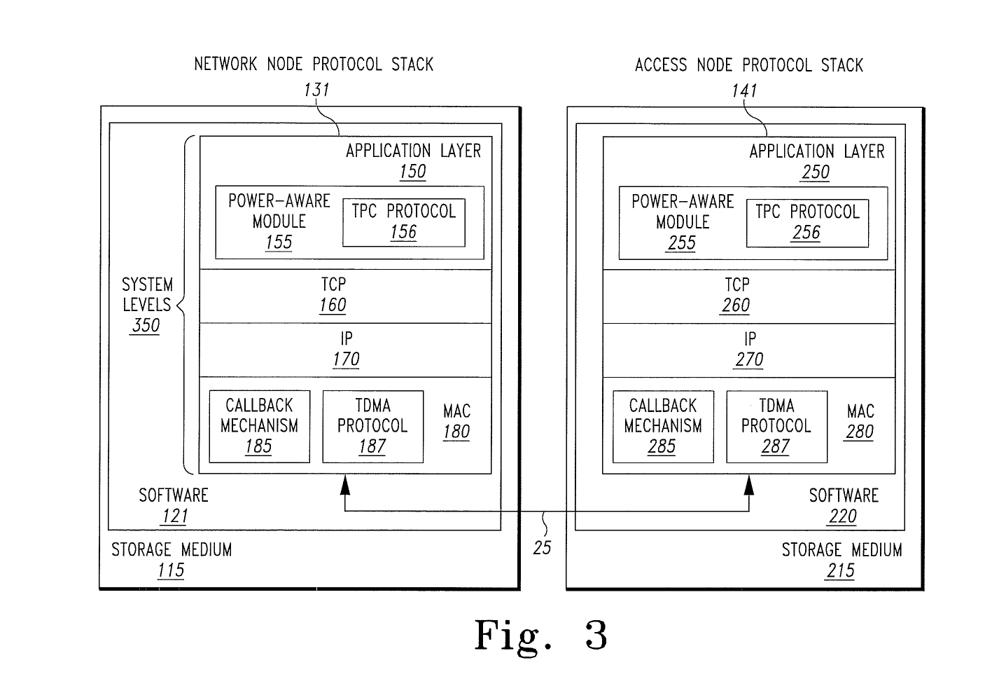

FIG. 3 is a block diagram of another embodiment of communication protocol stacks 131 and 141. In this embodiment, the wireless application-layer-managed network 10 (FIG. 1) implements a TDMA protocol in the media access control layer. The TDMA protocol is centrally controlled by the access node 100. The network node protocol stack 131 and the access node protocol stack 231 provide time division multiple access capability to the respective network nodes 102-106 and the access node 100 (FIG. 1). The communication protocol stack for the access node generally indicated as 141 is also referred to here as “access node protocol stack 141.” The communication protocol stack for the network nodes 102-108 generally indicated as 131 is also referred to here as “network node protocol stack 131.”

The network node protocol stack 131 and the access node protocol stack 141 differ from the network node protocol stack 130 (FIG. 2) and access node protocol stack 140 (FIG. 2) in that the media access control layers 180 and 285 include time division multiple access (TDMA) protocol 187 and 287, respectively, for a time division multiple access scheme to prevent data transmission collisions within the wireless application-layer-managed network 10 (FIG. 1).

In one implementation of this embodiment, the access node protocol stack 141 is the same as the network node protocol stack 131. Similarly, in some implementations of this embodiment, one or more of the application layer 250, the transmission control protocol layer 260, the internet protocol layer 270, the media access control layer 280, the TDMA protocol 287, the power-aware module 255 and the callback mechanism 285 are the same as one or more of the application layer 150, the transmission control protocol layer 160, the internet protocol layer 170, the media access control layer 180, the TDMA protocol 187, the power-aware module 155 and the callback mechanism 185, respectively.

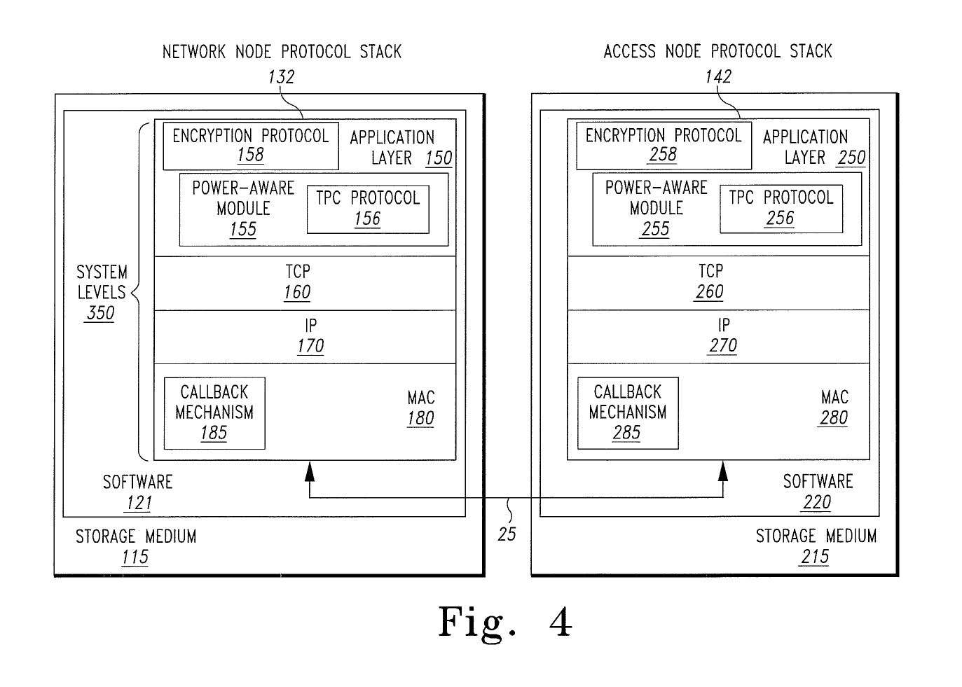

FIG. 4 is a block diagram of another embodiment of communication protocol stacks 132 and 142. In this embodiment, the network node protocol stack 132 and the access node protocol stack 142 provide encryption capability to the respective network nodes 102-106 and the access node 100 (FIG. 1). The communication protocol stack for the access node generally indicated as 142 is also referred to here as “access node protocol stack 142.” The communication protocol stack for the network nodes 102-108 generally indicated as 132 is also referred to here as “network node protocol stack 132.”

The network node protocol stack 132 differs from the network node protocol stack 130 (FIG. 2) in that the application layer 150 includes encryption protocol 158. In one implementation of this embodiment, the encryption protocol 158 provides secure symmetric cryptography with dynamic key derivation for the linked network nodes 102-108. The access node protocol stack 142 differs from the access node protocol stack 140 (FIG. 2) in that the application layer 250 includes encryption protocol 258 to provide secure symmetric cryptography with dynamic key derivation for the access node 100.

In one implementation of this embodiment, the access node protocol stack 142 is the same as the network node protocol stack 132. Similarly, in some implementations of this embodiment, one or more of the application layer 250, the transmission control protocol (TCP) layer 260, the internet protocol (IP) layer 270, the media access control (MAC) layer 280, the encryption protocol 258, the power-aware module 255 and the callback mechanism 285 are the same as one or more of the application layer 150, the transmission control protocol (TCP) layer 160, the internet protocol (IP) layer 170, the media access control (MAC) layer 180, encryption protocol 158, the power-aware module 155 and the callback mechanism 185, respectively.

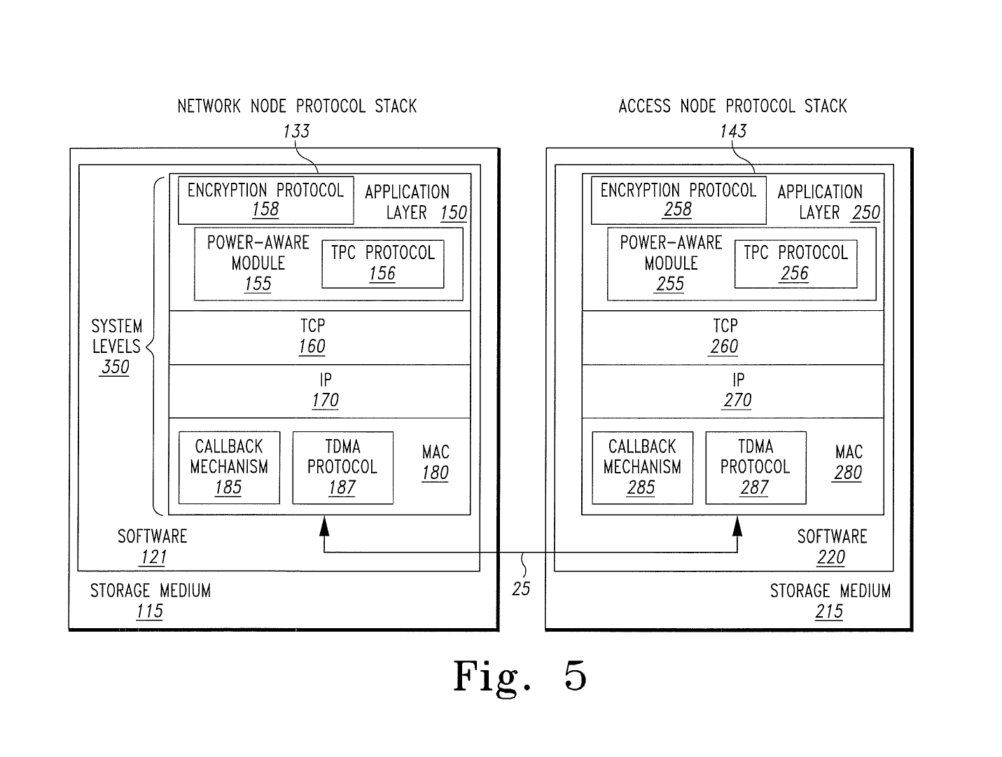

FIG. 5 is a block diagram of another embodiment of communication protocol stacks 133 and 143. In this embodiment, the network node protocol stack 133 and the access node protocol stack 143 provide time division multiple access capability and encryption capability to the respective network nodes 102-106 and the access node 100 (FIG. 1). The communication protocol stack for the access node generally indicated as 143 is also referred to here as “access node protocol stack 143.” The communication protocol stack for the network nodes 102-108 generally indicated as 133 is also referred to here as “network node protocol stack 133.”

The network node protocol stack 133 differs from the network node protocol stack 130 (FIG. 2) in that the application layer 150 includes encryption protocol 158 to provide secure symmetric cryptography with dynamic key derivation for the linked network nodes 102-108 and the media access control layer 180 includes time division multiple access (TDMA) protocol 187 for a time division multiple access scheme to prevent data transmission collisions within the wireless application-layer-managed network 10 (FIG. 1).

In this implementation of the application-layer-managed network 10, the network node 102-108 has an application layer 150 that includes a transmit-power control (TPC) protocol 156 operable to control transmission power levels from the respective network node 102-108 communicatively coupled to the access node 100. The application layer 150 also includes encryption protocol 158 to provide secure symmetric cryptography with dynamic key derivation. The media access control layer 180 is in communication with the application layer 150 of the network node 102-108. The TDMA protocol 187 prevents signal collisions among the network nodes 100-108 linked to the access node 100.

The access node protocol stack 143 differs from the access node protocol stack 140 (FIG. 2) in that the application layer 250 includes encryption protocol 258 to provide secure symmetric cryptography with dynamic key derivation for the access node 100 and the media access control layer 280 includes time division multiple access (TDMA) protocol 287 for a time division multiple access scheme to prevent data transmission collisions within the wireless application-layer-managed network 10 (FIG. 1).

In this implementation of the application-layer-managed network 10, the access node 100 has an application layer 250 that includes a transmit-power control (TPC) protocol 256 operable to control transmission power levels of network nodes 102-108 communicatively coupled to the access node 100. The application layer 250 also includes encryption protocol 258 to provide secure symmetric cryptography with dynamic key derivation. The media access control layer 280 is in communication with the application layer 250 of the access node 100. The TDMA protocol 287 prevents signal collisions among the communicatively coupled network nodes 100-108.

In one implementation of this embodiment, the wireless application-layer-managed network 10 provides energy aware priority and dynamic bandwidth allocation for the linked network nodes 102-108 communicating encrypted signals. In another implementation of this embodiment, the network nodes 102-108 linked to the access node 100 are wireless sensors capable of detecting environmental parameters. In one implementation of this embodiment, the encrypted signals are included in encrypted data packets, wherein the application layer 250 includes a power-aware module 255, wherein the media access control layer 280 includes a callback mechanism 285 and wherein transmitted and received data packets are filtered by the callback mechanism 285.

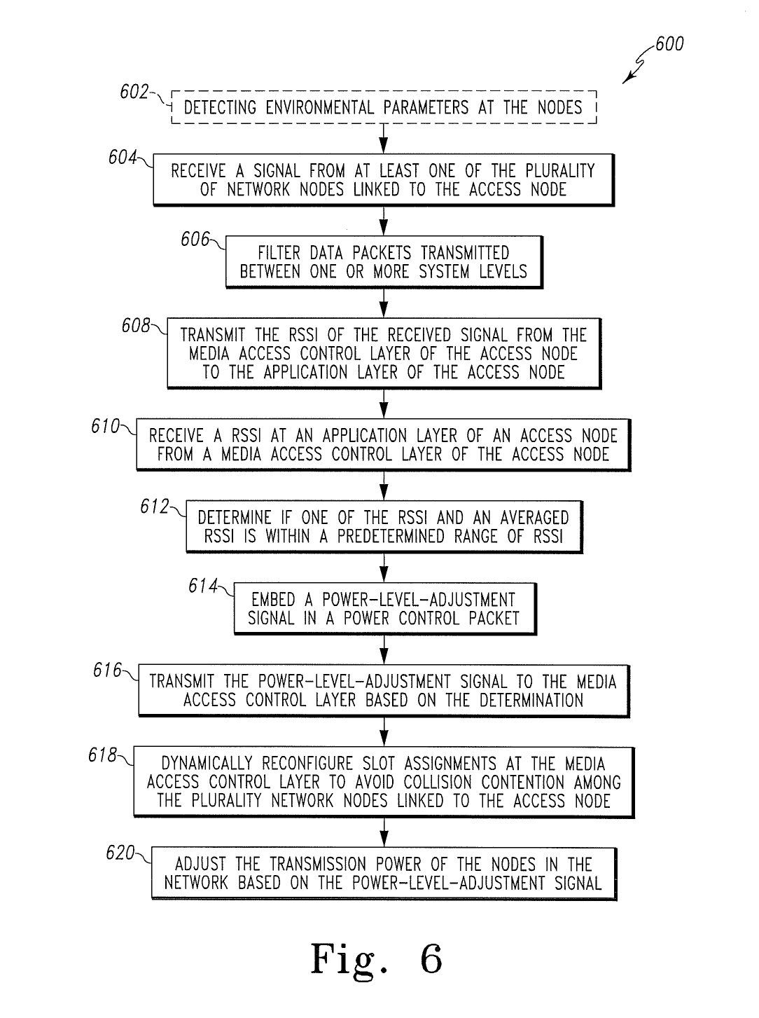

FIG. 6 is a flow diagram of one embodiment of a method 600 to manage the wireless application-layer-managed network 10 (FIG. 1). A program-product comprising program instructions is embodied on software 220 in the access node 100 and in the network nodes 102-208. The program instructions are operable to cause a processor 114 and 124 in the respective access node 100 and the network nodes 102-108 to perform the functions described as being carried out by the protocols in the respective access node protocol stack 140 and the network node protocol stack 130. Such program instructions are stored on or otherwise embodied on one or more items of storage media 115. The particular embodiment of method 600 shown in FIG. 6 is described here as being implemented in the access node protocol stack 140 and the network node protocol stack 130 described above with reference to FIG. 2.

Block 602 is only implemented if the network nodes 102-108 include one or more sensors 126. At block 602, the sensors 126 detect environmental parameters at one or more of the network nodes 102-108. In an implementation of this embodiment in which the network nodes 102-108 do not include one or more sensors 126, the network nodes 102-108 generate a signal. In one implementation of such a wireless application-layer-managed network 10, the network nodes 102-108 are mobile phones.

At block 604, the access node 100 receives a signal from at least one of the plurality of network nodes 102-108 linked to the access node 100. The signal is wirelessly communicated from one or more of the network nodes 102-108 communicatively coupled to the access node 100 via wireless communication link 25 (FIG. 2).

At block 606, the processors 114 execute software 220 in the callback mechanism 285 to filter the data packets transmitted between one or more system levels 350 in the access node 100. The power-aware processors 114 execute the software 220 to send power control updates to the network nodes 102-108 and to receive power control updates from the network nodes 102-108. The power-aware processors 114 use filters in the callback mechanism 285 to register an interest at the user-level 250 in certain data packets sent from or received by the access node 100. Depending on the filter that is set, the processors 114 execute algorithms to generate a callback to the power-aware module 255 in the application layer 250 upon transmission or receipt of the filtered packet. The callback information includes a copy of the transmitted packet.

At block 608, the power-aware processors 114 in the access node 100 execute software 220 at the media access control layer 280 to transmit a received signal strength indication (RSSI) of the received signal to the application layer 250 of the access node 100. At block 610, the power-aware module 255 in the application layer 250 of the access node 100 receives the RSSI from the media access control layer 280 of the access node 100. As described above with reference to FIG. 2, the architecture of the access node protocol stack 140 of the access node 100 consists of the callback mechanism 285 at the media access control layer 280 and algorithms in the transmit-power control (TPC) protocol 256 of the power-aware module 255.

At block 612, the processors 114 execute software 220 to determine if either the RSSI or an averaged RSSI is within a selected range of received signal strength indication. The power-aware processors 114 execute the software 220, such as transmit-power control protocol 256 in the power-aware module 255, to make this determination. The selected range of received signal strength indication is stored in a memory (not shown) in the storage medium 215.

At block 614, a power-level-adjustment signal is embedded in a power-control packet by the transmit-power control protocol 256. The power-level-adjustment signal is embedded in a user datagram protocol/Internet protocol (UDP/IP) or transmission control protocol/Internet protocol (TCP/IP) packet that implements the application-layer 250 transmit-power control (TPC) protocol 256. If it is determined at block 612 that the RSSI or the averaged RSSI is not within a selected range of RSSI, the processors 114 execute software 220 to generate the power-level-adjustment signal and to embed the power-level-adjustment signal in a power-control packet by the transmit-power control protocol 256. Depending on the environmental condition and the required operating conditions, the transmit power control algorithm computes a set of discrete values for transmission power for each range of RSSI values. The transmit power control algorithm builds a lookup table for mapping RSSI reading to the corresponding required transmit power. The wireless application-layer-managed network 10 achieves higher performance for power adjustment computation as well as less interactive demand of the computation resources by the use of the lookup table

In one embodiment of the implementation, the power-aware module 255 obtains the physical layer radio parameters such as minimum and maximum transmit power levels, receiver sensitivity, preset power levels from the Management Information Base (MIB) contained in storage medium 215. The power-aware module 255 divides the transmit power range (maximum transmit power level minus minimum transmit power level) in to a set of discrete values. Then the power-aware module 255 maps the range of RSSI values to the set of discrete power levels. If it is determined at block 612 that the RSSI or the averaged RSSI is within a selected range of RSSI, the processors 114 do not execute software 220 to generate the power-level-adjustment signal. If the RSSI or the averaged RSSI falls outside the selected range of RSSI, a power-level-adjustment signal is generated to increase or decrease the transmit power levels of future transmissions.

At block 616, the processors 114 execute software 220 in power-aware module 255 of the application layer 250 to transmit the power-level-adjustment signal embedded in the user datagram protocol/Internet protocol (UDP/IP) or transmission control protocol/Internet protocol (TCP/IP) packet to the media access control layer 280 based on the determination, at block 612, that the RSSI or the averaged RSSI is not within a selected range of RSSI.

During implementation of blocks 612, 614 and 616, the transmit-power control protocol 256 determines the level of data traffic to and from the access node 100 and then communicates power-level-adjustment signal embedded in a UDP/IP or TCP/IP packet to the media access control layer 280.

At block 618, the processors 114 in the access node 100 execute software 220 at the media access control layer 280 to dynamically reconfigure slot assignments at the media access control layer 280 to avoid collision contention among the plurality network nodes 102-108 linked to the access node 100. The media access control 280 transmits the power-level-adjustment signal embedded in the UDP/IP or TCP/IP packets to the media access control layer 180 of the network node 102, 104, 106 and/or 108 that require a transmit-power level adjustment. In one implementation of this embodiment, the power-level-adjustment signal and a new slot assignment is embedded in the UDP/IP packets. In another implementation of this embodiment, there is no power-level-adjustment signal embedded in the UDP/IP packet and a new slot assignment is embedded in the UDP/IP packets.

At block 620, the network node 102, 104, 106 and/or 108 that receives the power-level-adjustment signal adjusts the transmission power of the network node 102, 104, 106 and/or 108 in the wireless application-layer-managed network 10 based on the power-level-adjustment signal. The power-level-adjustment signal is operable to adjust the transmit-power level of the signals sent from the network nodes 102-108. The power-aware processors 124 receive the power-level-adjustment signal and execute software 121 in the media access control layer 180 to adjust the power level of all subsequent signal transmissions.

If the access node 100 determined that the network node 102, 104, 106 and/or 108 was transmitting too much power, the transmit power from the network node 102, 104, 106 and/or 108 is reduced. Likewise, if the access node 100 determined that the network node 102, 104, 106 and/or 108 was transmitting too little power, the transmit power from the network node 102, 104, 106 and/or 108 is increased. If the RSSI received at the access node 100 at block 604 was in the selected range of received signal strength indication, then the transmit power of the network node 102, 104, 106 and/or 108 is not adjusted.

The callback mechanisms 185 and 285 allow the power-aware modules 155 and 255, respectively, at each endpoint of the wireless communication link 25 to determine when to send transmit-power-control packets. In this manner, the callback mechanism 285 interfaces with the TPC protocol 256 to monitor which packets have been received, from which network node 102-108, and with what RSSI.

The power-aware module 255 at the access node 100 is operable to recognize when an additional network node initiates communication with the access node 100. Specifically, when an additional network node initiates communication with the access node 100, the callback mechanism 285 recognizes a new connection to an unknown destination in the wireless application-layer-managed network 10 has occurred. Then the callback mechanism 285 sends synchronization information to the power-aware module 255 in the application layer 250. Upon receiving this synchronization information from the same network as the wireless application-layer-managed network 10, the power-aware module 255 generates a power-level-management signal for transmission to the unknown destination, containing such parameters as the default and/or current transmit power level of the new network node as well as the discrete power levels available at the new network node. In this manner when the first data packet from an additional network node arrives at the receiver 110 in the access node 100, the power-aware module 255 is informed.

In one implementation of this embodiment, all network nodes 102-108 start transmission at the same default transmit power. After the receipt of the first data packet from a network node, the power-aware module 255 in the access node 100 calculates the optimal transmit power and sends a power-level-adjustment signal to the media access control layer 180 in the new network node to reset its transmit power.

The access node 100 reactions are largely data-driven, and remain one step behind the kernel's arriving data, due to the passive callback monitoring. As more data packets arrive at the access node 100, the RSSI is continually monitored, and if a sufficiently large change has occurred, the access node 100 power-aware module 255 reacts by transmitting an update control packet containing the new optimal transmit power to the network node 100, 102, 104, 106 and/or 108. If the default transmit power is known a priori, then it is only necessary to send transmit power updates from access node 100 to data network node 102-108, and not vice versa. In this manner, both endpoints of the wireless communication link 25 are loosely synchronized about the current state of transmit power level.

The wireless application-layer-managed network 10 is self correcting even if one or more power-level-adjustment signal from the access node 100 are lost, due to unreliable datagram delivery over wireless communication links 25 and both the access node 100 and the network node 100-108 lose synchronization. In one implementation of this case, the unsynchronized network node 100-108 transmits at too high a power for a short time until the access node 100 power-level-adjustment signal is received at the unsynchronized network node 100-108. Alternatively, the unsynchronized network node 100-108 transmits at too low a power and the access node 100 does not receive the data from the unsynchronized network node 100-108. The unsynchronized network node 100-108 then goes into a timeout, prompting a power-level-adjustment signal to be sent from the access node 100. In either case, communication between the access node 100 and the unsynchronized network node 100-108 is reestablished.

In this manner, application-level transmit-power control (TPC) protocol minimizes transmission power based on received signal strength to extend lifetime of stored-energy-powered networks, such as wireless application-layer-managed network 10. The protocol increases transmission power as the Bit Error Rate (BER) increases in order to maintain a selected BER.

The TPC protocol 256 averages the RSSI to approximate the Signal-to-Noise Ration (SNR) using a linear equation. RSSI takes into consideration multi-path fading, shadowing, and path loss to compute the optimal transmitter power. The TPC protocol 256 is receiver-driven and asymmetric since the transmit power of the access point does not need to be adjusted in the same way for the stored-energy-powered nodes. In one implementation of this embodiment, the wireless application-layer-managed network 10 includes bidirectional power control and the network nodes 102-108 control the power levels transmitted from the access node 100.

The method 600 is incrementally deployable. The wireless application-layer-managed network 10 can function even if one of more of the network nodes is not configured to implement the transmit-power control protocol. A network node that is not configured to implement the transmit-power control protocol is referred to here as a “non-TPC network node.” When a non-TPC network node receives signals from the access node 100, the power level adjustment signals are dropped by the non-TPC network node, due to lack of a receiving peer process. Data is transmitted to the non-TPC network node at non-adjusted power levels. As a result, data at adjusted power levels is exchanged between network nodes 102-108 with adaptive transmit power capability, while data at non-adjusted power levels is exchanged without the adaptive transmit power among nodes with fixed transmit power levels.

Method 600 is inherently transparent to the application since the adjustment of transmit power occurs outside of the flow of application data. Applications do not need to be rewritten, and packets do not need to be modified for use in the wireless application-layer-managed network 10. Likewise, protocol stacks need not be modified except to compile in the existing patches.

The architecture implemented in method 600 is compatible with a wide variety of wireless standards including 802.11b/g. All application-level control packets for updating the transmit power are communicated in-band. In one implementation of this embodiment, the user-level approach of method 600 is overlaid upon any wireless system with adjustable transmit powers, including 802.11 b/g.

The method 600 enables experimentation and/or upgrade/deployment of new adaptive algorithms. In one implementation of this embodiment, the application is loaded to the network node 102-108 from the access node 100 as a Java application.

The TPC protocol 256 is an application-layer entity that is incrementally deployable, inherently transparent to the applications, and compatible with a wide variety of underlying wireless networks. The TPC protocol 256 recalculates the optimal transmit power only when the RSSI falls outside the selected range of received signal strength indication to reduce the communication overhead of transmit power updates.

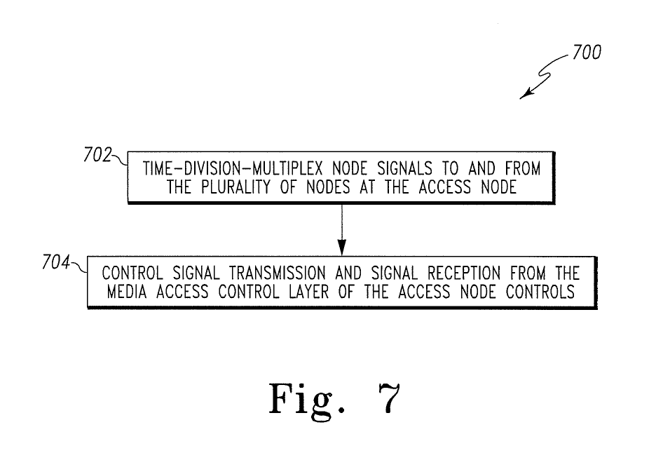

FIG. 7 is a flow diagram of one embodiment of a method 700 to dynamically reconfigure slot assignments in the wireless application-layer-managed network 10. In one implementation of this embodiment, the power-aware network 10 is implemented with protocol stacks 131 and 141 as described above with reference to FIG. 3. In another implementation of this embodiment, the power-aware network 10 is implemented with protocol stacks 133 and 143 as described above with reference to FIG. 5. The method 700 is implemented as block 618 in method 600 as described above with reference to FIG. 6. At block 702, the access node 100 time-division-multiplexes the node signals transmitted to and from the plurality of network nodes 102-108. At block 704, the media access control layer 280 of the access node 100 controls signal transmission and signal reception.

The access node 100 is responsible for assigning time slots for each network node 102-108, informing each network node 102-108 when to wake up and send and/or receive data to conserve the constrained energy resource of each network node 102-108.

In one implementation of this embodiment, the access node 100 maintains an energy model for each network node 102-108 to keep track of the energy reserves for each network node 102-108. The energy-aware protocol implemented by the wireless application-layer-managed network 10 applies priority, preemption and dynamic bandwidth allocation to ensure deterministic, time-critical and reliable performance of the wireless application-layer-managed network 10.

The energy-aware protocol is flexible, where slot assignment can be adapted to match the node energy reserve, the priority, the communication environment, and application workloads. The energy-aware communication protocol implemented by the wireless application-layer-managed network 10 is based on collision-free TDMA-based MAC protocol and energy-aware routing protocol to extend lifetime of stored-energy-powered network. The TDMA MAC protocol is predictable, contention-free and thereby enhances the Quality of Service (QoS) of data delivery. The TDMA MAC protocol is scalable as the number of network nodes increases.

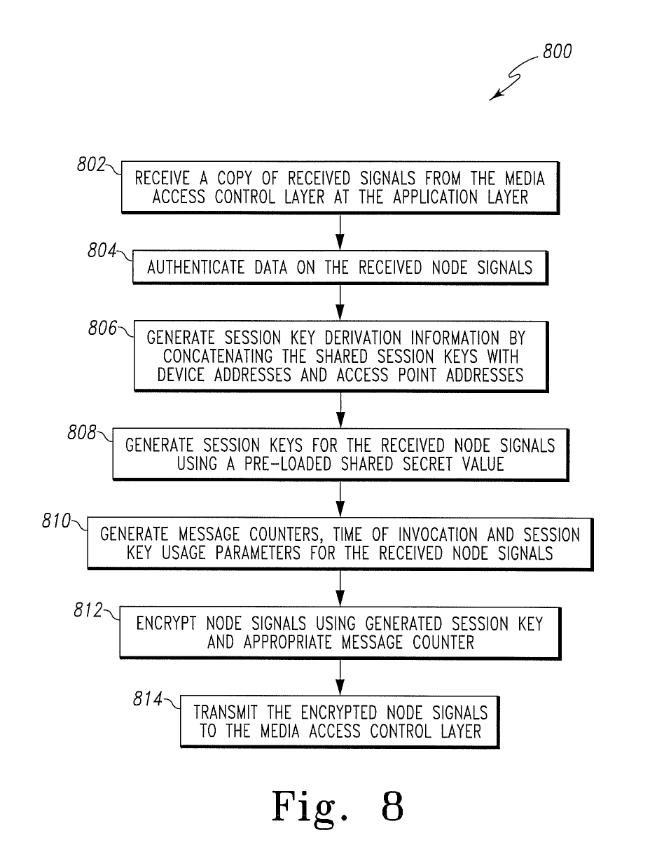

FIG. 8 is a flow diagram of one embodiment of a method 800 to encrypt data on signals received at the wireless application-layer-managed network 10. In one implementation of this embodiment, the power-aware network 10 is implemented with protocol stacks 132 and 142 as described above with reference to FIG. 4. In another implementation of this embodiment, the power-aware network 10 is implemented with protocol stacks 133 and 143 as described above with reference to FIG. 5.

At block 802, the application layer 250 in access node 100 receives a copy of signals from the media access control layer 280. At block 804, the processor 114 executes software 220 in the encryption protocol 258 to authenticate the signals received from the network nodes 102-108. In one implementation of this embodiment, the encryption protocol 158 provides secure symmetric cryptography with dynamic key derivation for the linked network nodes 102-108 and block 806, block 808 and block 810 are implemented.

At block 806, the processor 114 executes software 220 in the encryption protocol 258 to generate session key derivation information by concatenating the shared session keys with device addresses and access point addresses. At block 808, the processor 114 executes software 220 in the encryption protocol 258 to generate session keys for the signals using a pre-loaded shared secret value. In one implementation of this embodiment, the pre-loaded shared secret value is stored in a memory (not shown) in the storage medium 215. The session key message authentication code verification algorithm reconstructs the message key authentication code from the retrieved user data and verifies it against the received message authentication code. In one implementation of this embodiment, the parameter exchanges are both encrypted and message-authentication-coded. In another implementation of this embodiment, the parameter exchanges are message-authentication-coded but not encrypted.

At block 810, the processor 114 executes software 220 in the encryption protocol 258 to generate message counters, time of invocation and session key usage parameters for the received node signals. At block 812, the processor 114 executes software 220 in the encryption protocol 258 to encrypt node signals using the generated session key and the appropriate message counter. At block 814, the processor 114 executes software 220 in the encryption protocol 258 to transmit the encrypted signals to the media access control layer 280.

In this manner the wireless application-layer-managed network 10 provides authentication, encryption, and decryption to prevent hacking, spoofing, masquerade and unauthorized disclosure. In one implementation of this embodiment, the access node 100 dynamically generates session keys based on: a hashing function, such as security hash algorithm 1 (SHA-1); the pre-loaded shared secret value; session key derivation information (shared key derivation parameter concatenated with the devices address and the access point address); message counters (zeroed); time of invocation; and session key usage parameter. In this implementation the access node 100 verifies received signals using a hashed message authentication code (HMAC) algorithm in the encryption protocol 258 over the message authentication code data (user data concatenated with the message counter) using the session key. Then the access node 100 invalidates and reinitiates keys once the session is terminated to protect against play-back attacks.

In a specific implementation of this embodiment, the wireless application-layer-managed network 10 is implemented using IEEE 802.15.4 wireless devices. In this implementation of the embodiment, the network nodes 102-108 in the wireless application-layer-managed network 10 are asleep most of the 1-second duty cycle and wake up for only one time slot of 4.8 milliseconds. In this case, the wireless application-layer-managed network 10 provides an energy saving of a factor of 200. In yet another implementation of this embodiment, the wireless application-layer-managed network 10 is implemented according to Bluetooth standards. In yet another implementation of this embodiment, the wireless application-layer-managed network 10 is implemented according to 802.11 standards. In yet another implementation of this embodiment, the encryption is implemented using algorithms in the software 220 and 120 that are similar to hashing function algorithms.

The methods and techniques described here may be implemented in digital electronic circuitry, or with a programmable processor (for example, a special-purpose processor or a general-purpose processor such as a computer) firmware, software, or in combinations of them. Apparatus embodying these techniques may include appropriate input and output devices, a programmable processor, and a storage medium tangibly embodying program instructions for execution by the programmable processor. A process embodying these techniques may be preformed by a programmable processor executing a program of instructions to perform desired functions by operating on input data and generating appropriate output. The techniques may advantageously be implemented in one or more programs that are executable on a programmable system including at least one programmable processor coupled to receive data and instructions from, and to transmit data and instructions to, a data storage system, at least one input device, and at least one output device. Generally, a processor will receive instructions and data from a read-only memory and/or a random access memory.

Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and DVD disks. Any of the foregoing may be supplemented by, or incorporated in, specially-designed application-specific integrated circuits (ASICs).

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A method to manage an application-layer-managed network, the method comprising:
receiving a received signal strength indication at an application layer of an access node from a media access control layer of the access node;
determining if one of the received signal strength indication and an averaged received signal strength indication is within a selected range of received signal strength indication; and
transmitting a power-level-adjustment signal to the media access control layer based on the determination, the power-level-adjustment signal adapted to adjust a transmission power level of at least one of a plurality of network nodes.

2. The method of claim 1, further comprising:
adjusting the transmission power of the nodes in the network based on the power-level-adjustment signal.

3. The method of claim 1, wherein transmitting the power-level-adjustment signal comprises
embedding the power-level-adjustment signal in a power-control packet.

4. The method of claim 3, the method further comprising:
filtering data packets transmitted between one or more system levels.

5. The method of claim 1, further comprising:
receiving a signal from the at least one of the plurality of network nodes linked to the access node;
transmitting the received signal strength indication of the received signal from the media access control layer of the access node to the application layer of the access node; and
dynamically reconfiguring slot assignments at the media access control layer to avoid collision contention among the plurality of network nodes linked to the access node.

6. The method of claim 5, wherein the dynamically reconfiguring slot assignments comprises:
time-division-multiplexing node signals to and from the plurality of network nodes at the access node; and
controlling signal transmission and signal reception from the media access control layer of the access node.

7. The method of claim 5, further comprising:
receiving a copy of received signals from the media access control layer at the application layer; and
encrypting data on the received signals at the application layer of the access node.

8. The method of claim 7, wherein the encrypting data includes using symmetric cryptography with dynamic key derivation, and wherein the encrypting data comprises:
authenticating data on the received node signals;
generating session keys for the received node signals using a pre-loaded shared secret value;
generating session key derivation information by concatenating the shared session keys with device addresses and access point addresses;
generating message counters, time of invocation and session key usage parameters for the received node signals; and
transmitting the encrypted node signals to the media access control layer.

9. The method of claim 1, further comprising:
receiving a copy of received signals from the media access control layer at the application layer; and
encrypting data on the received signals at the application layer of the access node.

10. The method of claim 9, wherein the encrypting data uses symmetric cryptography with dynamic key derivation and wherein the encrypting comprises:
authenticating data on the received signals;
generating session keys for the received signals using a pre-loaded shared secret value;
generating session key derivation information by concatenating the shared session keys with device addresses and access point addresses;
generating message counters, time of invocation and session key usage parameters for the received node signals; and
transmitting the encrypted node signals to the media access control layer.

11. The method of claim 1, wherein the network nodes are wireless sensors, the method further comprising:
detecting environmental parameters at the network nodes.

12. An application-layer-managed network, the network comprising:
a plurality of network nodes;
an access node having an application layer, the access node communicatively coupled to the plurality of network nodes;
wherein the application layer includes a transmit-power control protocol adapted to control transmission power levels of the plurality of network nodes and the application layer further includes an encryption protocol adapted to provide secure, symmetric cryptography with dynamic key derivation; and
a media access control layer in communication with the application layer of the access node, the media access control layer including protocol for a time division multiple access scheme to prevent signal collisions among the linked network nodes,
wherein the application layer managed network provides energy aware priority and dynamic band width allocation for the linked network nodes communicating encrypted signals.

13. The network of claim 12, wherein the network nodes linked to the access node are wireless sensors capable of detecting environmental parameters.

14. The network of claim 12, wherein the encrypted signals are included in encrypted data packets, wherein the application layer includes a power-aware module, wherein the media access control layer includes a callback mechanism and wherein transmitted and received data packets are filtered by the callback mechanism.

15. A program-product comprising program instructions, embodied on a storage medium, that are adapted to cause a programmable processor to:
receive a received signal strength indication at an application layer of an access node from a media access control layer of the access node;
determine if one of the received signal strength indication and an averaged received signal strength indication is within a selected range of received signal strength indication; and
transmit a power-level-adjustment signal to the media access control layer based on the determination, the power-level-adjustment signal adapted to adjust a transmission power level of at least one of a plurality of network nodes.

16. The program-product of claim 15, further comprising instructions adapted to cause the programmable processor to:
adjust the transmission power of the nodes in the network based on the power-level-adjustment signal.

17. The program-product of claim 16, further comprising instructions adapted to cause the programmable processor to:
filter data packets transmitted between one or more system levels.

18. The program-product of claim 16, further comprising instructions adapted to cause the programmable processor to:
receive a signal from the at least one of the plurality of network nodes linked to the access node;
transmit the received signal strength indication of the received signal from the media access control layer of the access node to the application layer of the access node; and
dynamically reconfigure slot assignments at the media access control layer to avoid collision contention among the plurality nodes linked to the access node.

19. The program-product of claim 16, further comprising instructions adapted to cause the programmable processor to:
receive a copy of received signals from the media access control layer at the application layer; and
encrypt data on the received signals at the application layer of the access node.

20. The program-product of claim 19, further comprising instructions adapted to cause the programmable processor to:
authenticate data on the received signals;
generate session keys for the received signals using a pre-loaded shared secret value;
generate session key derivation information by concatenating the shared session keys with device addresses and access point addresses;
generate message counters, time of invocation and session key usage parameters for the received node signals; and
transmit the encrypted node signals to the media access control layer.
